(19) United States
(12) Patent Application Publication
(10) Pub. No.: US 2014/0049111 A1
(43) Pub. Date: Feb. 20, 2014

(54) ENERGY COLLECTION SYSTEM AND METHOD WITH INDIVIDUAL REGULATION OF POWER UNITS

(71) Applicants: Noam Noy, Netanya (IL); Ronny Izhak, Rishon-Lezion (IL)

(72) Inventors: Noam Noy, Netanya (IL); Ronny Izhak, Rishon-Lezion (IL)

(21) Appl. No.: 14/114,242

(22) PCT Filed: Apr. 28, 2011
(86) PCT No.: PCT/IL11/00344

§ 371 Date: Oct. 28, 2013

(51) Int. Cl. G05F 3/02

(52) U.S. Cl. CPC G05F 3/02
USPC 307/63

(57) ABSTRACT

Apparatus and method are disclosed which include a string of units including at least two electrical energy producing units connected in series and providing string current. Each of the units is adapted to provide the electrical energy via output terminals. The apparatus further comprising a current equalization unit. The current equalization unit is adapted to individually control the magnitude and direction of current via that current equalization unit so that the algebraic sum of the current produced by its respective electrical energy producing unit when operated at a defined operational point and the current flowing via said current equalization unit equals to said string current. The operation of the apparatus enables transfer of energy from units with high production capacity to units with low production capacity without having to use a dedicated bus for that. The energy is transferred via the cabling of the string.

### BACKGROUND OF THE INVENTION

Many electric energy production techniques (such as photovoltaic (PV) energy production assemblies, batteries, fuel cells and others) utilize energy generation modules including a multiplicity of electric energy producing cells connected to each other in series and/or parallel connections. Typically, the operation of the cell is in accordance with a Current-Voltage curve (i.e., I-V curve) characteristic of the cell. The curve characterizes the operation of the energy-producing cell for a given cell (for example, in case of a photovoltaic cell, defined by the cell's dimensions and materials, e.g., single-/poly-crystalline silicon, amorphous silicon, Cadmium Telluride (CDTE) and other materials) and for certain operational conditions of the cell, e.g., determined by the operational temperature of the photovoltaic cell (which might affect its efficiency) and the amount of input energy to be converted by the cell to electric energy.

A multitude of energy producing cells connected in series to one another, generally termed a cell string or string, provides electric output having certain electric current which substantially equally flows within all the cells of the string. The output voltage of such string is the sum of each voltage generated by each respective cell in accordance with the corresponding I-V performance curve of each of the cells and with said certain electric current which flows through the cells of the string. FIG. 1A depicts typical performance curves of three PV cells (or PV sub-strings) P1, P2 and P3 which differ from one another by their available power. P1 represents a cell (or sub-string) with the highest power and P3 represents the performance of a cell with the lowest power. For each individual cell, the operational point in the domain may be individually selected, however, when the cells are connected in series the current flowing through them is equal, and therefore, may not be freely selected for each of the cells. Moreover, in order to comply with the constraints imposed by the cell of P3, the cells of P1 and P2 will be operated away from their individual maximum power point (MPP), denoted OP1, OP2 and OP3, respectively, thus causing waste of available power. When each of the cells (or sub-strings) is allowed to work at its individual MPP, the available power is indicated by the rectangular area with hatched margins extending from the I-V origin to the respective OP point.

Similarly, FIG. 1B depicts typical V-Q (voltage-discharge capacity) performance curves of three batteries B1, B2 and B3. As seen in FIG. 1B the three batteries have three different available charge capacities. Here, too, when such cells are connected in series, a common current flows trough them, and as a result, battery B1 (with the lowest charge capacity) will be emptied first, and will stop the operation of the battery string at that time, causing waste of unused charge in B2 and B3.

In other words, in the above string topologies, each cell is constrained to operate at a certain fixed point along its performance (I-V, V-Q or other) curve, which is determined in accordance with the value of said certain current. Said certain current is, in turn, dependent on the electric load on the entire cell string. Energy generation module may include an arrangement of multiple cell strings arranged in parallel branches connected with electrical connection with respect to one another such that the output currents from the so-connected cell strings are accumulated and the output voltage of the multiple cell strings is equal to one another.

For practical considerations (e.g., electrical efficiency of the conversion of the produced DC electrical energy into AC energy) the output voltage of the array of multiple cell strings may be in the range of several hundreds of Volts (e.g., 400-600 Volts). The number and types of cells in a cell string will be generally dictated by the required output voltage, while the number of strings will typically be dictated by the required output current. An energy generation module comprising multitude cell strings has a corresponding performance curve associated with the performance curves of all the cell strings in the module, while the performance curve of a string is associated with the performance curves of the individual cells and with the nature of the electric connection between the cells of the strings. In such a module, due to the parallel connection between the cell strings, the cell strings are forced to operate with an equal/similar output voltage. Ideally, the maximal power (energy) is collected from the multiple cells when all the cells operate at their maximal power operational point. In an array of cells connected in multiple parallel cell strings the working (operational) point of the array is dictated by the current consumed by the load of the array. As known in the art, the operational point may be controlled by a controller, such as a Maximal Power Point Tracker (MPPT) connected at the output of the array and adapted to control the operational point of the array by controlling the actual load of the array, thereby changing the total current of the array, which dictates the output voltage, according to the equivalent I-V performance curve of the whole array. Other known arrangements may involve more than one MPPT unit, which may enable individual control of, for example, each cell string and driving it to work at its individual maximal power point (MPP). However, such power harvesting arrangements are limited by the weakest cell in the cell string, or by the weakest sub-string in the cell string, or by the weakest cell string in the cell string array. Any attempt to drive a weak cell/weak cell string beyond its associated MPP will result in loss of power and may overheat and may even destroy that cell/cell string. Weakness of a cell may be due to high internal resistance, aging of the cell or because that cell being shaded more than other cells in the array (in case of a PV cell), etc. Furthermore, operating an array of power generator cells in a single operational point (e.g., the operational point of the array's MPP) causes loss of available power in the stronger cells, which may not be collected or harvested due to the operation away from their individual MPP.

### SUMMARY OF THE INVENTION

Apparatus and method are disclosed comprising a string of units, comprising at least two electrical energy producing units connected in series to provide string current. Each of said units is adapted to provide the electrical energy via output terminals. The apparatus may further comprise a current equalization unit connected to each of the at least two energy producing units via the output terminals. The current equalization unit may be adapted to individually control the magnitude and direction of current via that current equalization unit. The current equalization unit may be adapted to control the magnitude and direction of current via that current equalization unit so that the algebraic sum of the current produced by its respective electrical energy producing unit when operated at a defined operational point and the current flowing via said current equalization unit equals to said string current. The operation of the apparatus may thereby enable transfer of energy from units with high production capacity to units with low production capacity without having to use a dedicated bus therefor. The energy may be transferred via the cabling of the string.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1A depicts typical I-V performance curves of three PV cells;

FIG. 1B depicts typical V-Q (voltage-discharge capacity) performance curves of three batteries;

FIG. 1C depicts a set of simplified or approximated I-V performance curves of the three I-V curves of FIG. 1A;

FIG. 2 is a schematic illustration of a system for harvesting electrical energy from a series of cells connected in series, according to embodiments of the present invention;

FIG. 2A is a schematic illustration of a single compensation arrangement comprising electrical producing unit, compensation unit and a controller, according to embodiments of the present invention;

FIG. 2B is a schematic illustration of an array of electrical producing units each connected to a respective compensation unit and respective controller unit, according to embodiments of the present invention;

FIG. 2C is a schematic illustration of a string of electrical producing units each connected to a respective equalization unit, according to embodiments of the present invention;

FIG. 3 is a schematic illustration of a compensation unit, according to one embodiment of the present invention;

FIG. 3A depicts a compensating unit embodied using a transformer charge pump topology employing capacitors, transformer and switches according to embodiments of the present invention; and

FIG. 3B depicts a compensating unit embodied using a charge pump topology employing four capacitors and one switch, according to embodiments of the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE PRESENT INVENTION

There is a need for a control system and method to individually control substantially each and every cell/sub-string in an array of energy producing cells, so as to operate each such individual cell at its associated individual operational MPP, while enabling the harvesting of the energy produced from all of the cells in a coordinated manner. There is further need for allowing individual control of the operational point of each cell/sub string in an array of cells in a way that will not impose a need for substantial changes in the construction of standard cell array when individually controlling each cell/sub string in the array.

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

Unless specifically stated otherwise, as apparent from the following discussions, it is appreciated that throughout the specification discussions utilizing terms such as “processing,” “computing,” “calculating,” “determining,” or the like, refer to the action and/or processes of a computer or computing system, or computerized controller, or similar electronic computing device, that manipulate and/or transform data represented as physical, such as electronic, quantities within the computing system's registers and/or memories into memories into other data similarly represented as physical quantities within the computing system's memories, registers or other such information storage, transmission or display devices.

Embodiments of the present invention may include apparatus for performing the operation herein. This apparatus may be specially constructed for the desired purposes, or it may comprise a general-purpose computer selectively activated or reconfigured by a computer program stored in the computer. Such a computer program may be stored in a non-transitory computer readable storage medium, such as, but not limited to, any type of disk, including floppy disks, optical disks, magnetic-optical disks, read-only memories (ROM's), compact disc read-only memories (CD-ROM's), random access memories (RAM's), electrically programmable read-only memories (EPROM's), electrically erasable and programmable read only memories (EEPROM's), FLASH memory, magnetic or optical cards, or any other type of media suitable for storing electronic instructions and capable of being coupled to a computer system bus.

Embodiments of the invention may include an article such as a non-transitory computer or processor readable storage medium, such as for example a memory, a disk drive, or a USB flash memory encoding, including or storing instructions, e.g., computer-executable instructions, which when executed by a processor or controller, cause the processor or controller to carry out methods disclosed herein. The instructions may cause the processor or controller to execute processes that carry out methods disclosed herein

The variation in performance of the power generator cells in an array and the target of operating the array in optimal operating conditions has been addressed in PCT application number PCT/IL2010/000891, filed on Oct. 28, 2010 and entitled ENERGY COLLECTION SYSTEM AND METHOD, co-owned by the owner of the present invention, which is incorporated herein by reference in its entirety. According to embodiments disclosed in that application, power generator cells having power production capacity higher than the average capacity may convey extra energy (e.g., energy corresponding to current higher than I_{string}) may convey the extra energy to an energy-storing device, such as a capacitor, and the capacitor may disconnect from its respective cell and be connected to an energy-conveying bus. Similarly, and concurrently, cells with poor performance (e.g., having power capacity corresponding to current that is lower than I_{string}) may be connected to an energy-storing device (such as a capacitor) charged with electrical charge, and that energy-storing device may contribute current to that cell, so as to complete the missing current. When the energy-storing devices are disconnected from their respective cells and connected to the energy conveying bus and recharged by the extra charge received from the energy storing device of the first cell. In this fashion, each of the power generator cells is enabled to work in its optimal operational point and produce the respective current. Cells having currents higher than the cell string current may be used to charge energy storing devices, the extra charge may be conveyed, via a common energy bus, to energy storing devices associated with power generator cells having currents lower than the string current. Finally, the energy conveyed to the energy storing devices associated with low-performance cells may be turned into current that will complete the current produced by the cell to the level of I_{string}.

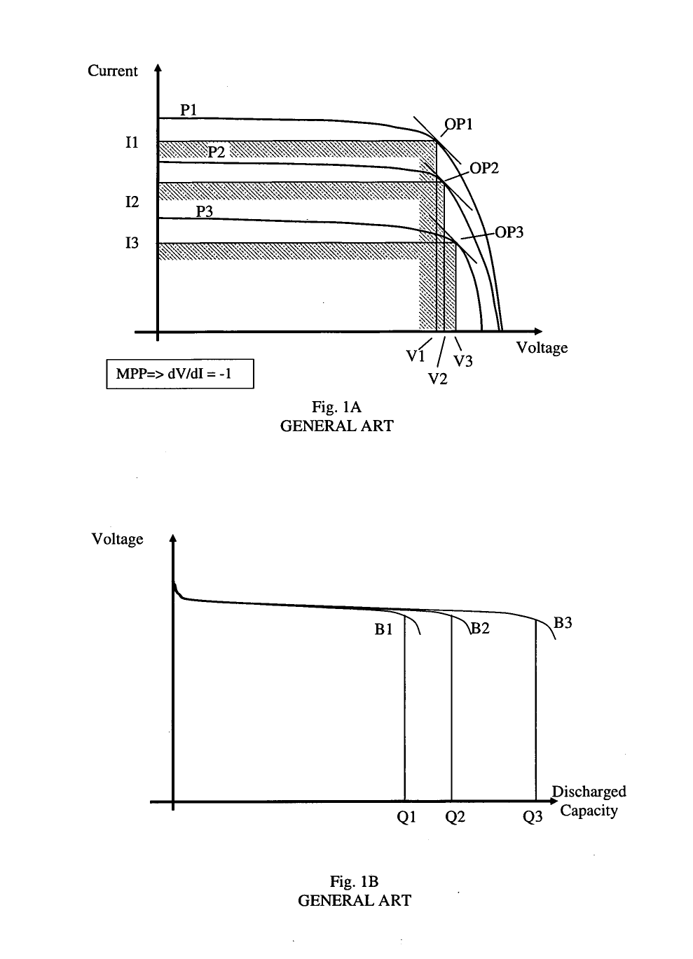

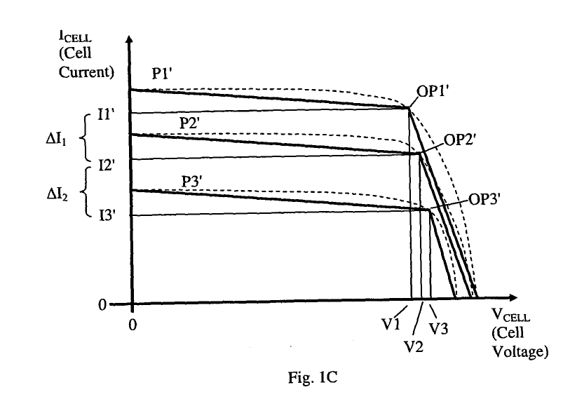

Reference is made now to FIG. 1C, which depicts a set of simplified or approximated I-V performance curves of the three I-V curves of FIG. 1A, of three different PV cells (or sub-strings). The approximated curves are bi-linear curves. A first linear portion of the bi-linear curve connects the point of short-cut (zero voltage) on the vertical (I) axis of the I-V plane to the knee-point OP on the original curve (here denoted OP′) and the other linear portion connects knee-point OP′ with zero current point on the horizontal (V) axis. In some embodiments of the present invention, the approximated bi-linear curves of FIG. 1C provide sufficiently accurate results for some calculations that may be performed in embodiments of the present invention. The variation of current as the voltage of a cell changes from zero to the voltage of the knee-point (V1, V2, V3) are in the order of magnitude of less than 1 Ampere. Thus, variation of the output current of a PV cell (or sub string) of 1 Ampere may correspond to variations of 0—V1 (or to V2 or V3), which typically is in the range of 0-30 Volt. Current I1′, I2′ and I3′, which correspond to the voltage of the knee points V1, V2 and V3 respectively, may differ from one another. For example, as is depicted in FIG. 1C, I1′ is bigger than I2′ by ΔI₁ and I2′ is bigger than I3′ by ΔI₂.

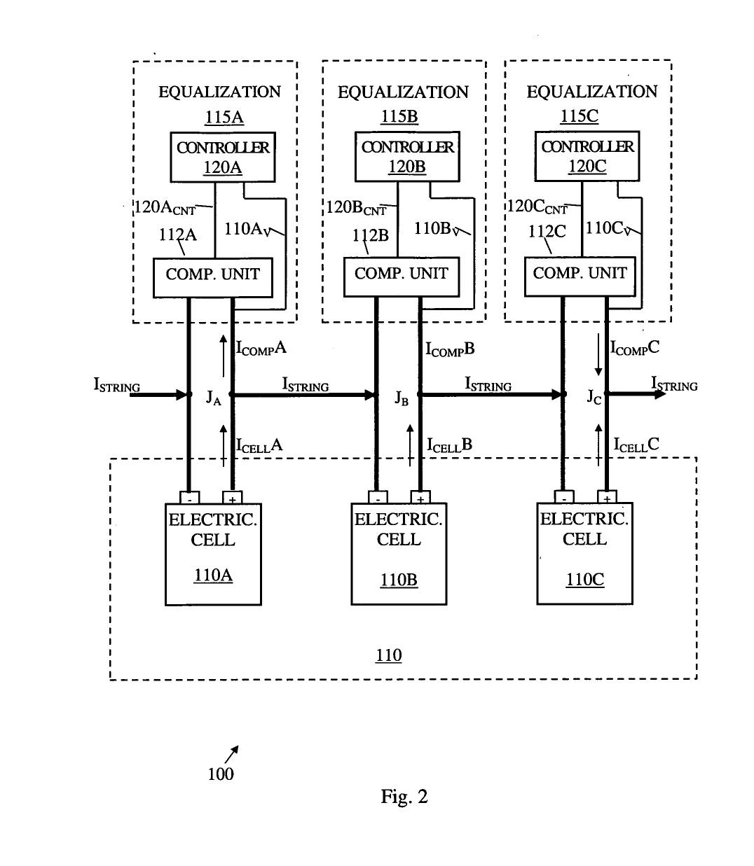

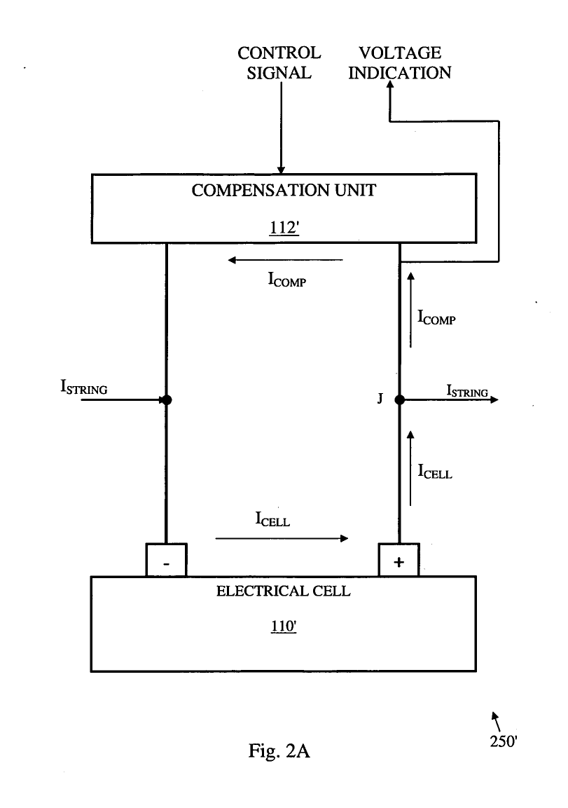

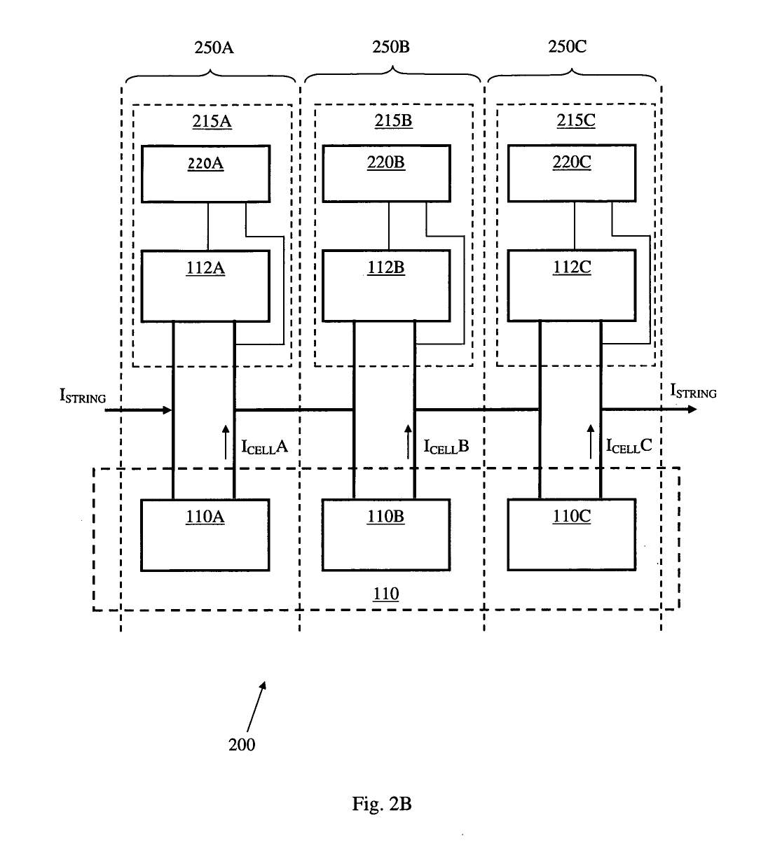

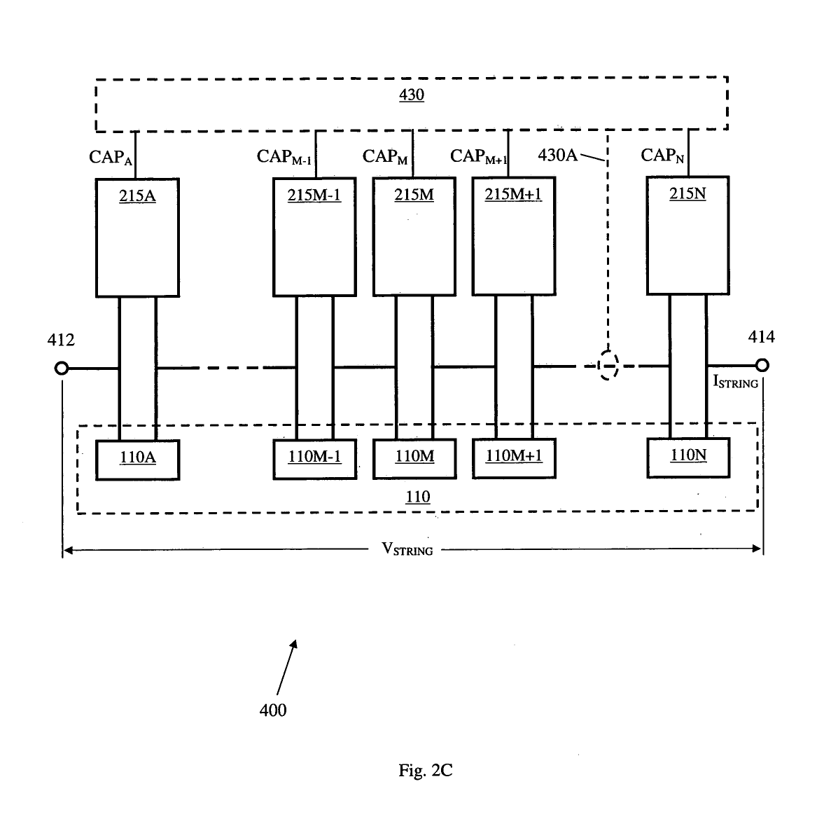

Reference is made now to FIG. 2, which is a schematic illustration of system 100 for harvesting electrical energy from a series of cells (or sub strings) connected in series, according to embodiments of the present invention. System 100 may comprise an array 110 of electrical producing units or cells 110A, 110B, 110C, etc., which are connected in series. FIG. 2 presents three electrical producing units only, however it will be apparent to one skilled in the art that any number of such units, from two on, may be connected in series according to the arrangement of FIG. 2. Electrical producing cells 110A, 110B, 110C may be PV cells (or sub strings of PV cells), batteries, fuel cells and others. Each of electrical producing units 110A, 110B, 110C is connected in parallel to an equalization unit 115A, 115B, 115C respectively, so that current I_{STRING} flowing via system 100 may flow via an electrical producing cell only, or via that cell and its respective equalization unit, according to the operation conditions. Each equalization unit comprising current/charge compensating unit 112 (112A, 112B, 112C) and controller 120 (120A, 120B, 120C), respectively. Each of compensating units 112A, 112B, 112C is adapted to compel flow of current through it in a controllable direction and magnitude. Each of controller units 120A, 120B, 120C may receive indication of the voltage across the output terminals of its respective cell, for example via signal line 110A_{V}, 110B_{V}, 110C_{V} and may produce a control signal 120A_{CNT}, 120B_{CNT}, 120C_{CNT} to control the operation of its respective compensate unit so as to set the direction and magnitude of current flowing through the compensating unit.

In some embodiments of the invention, electrical producing units 110A, 110B, 110C may some or each have different electricity production capacity. In case of PV units, this may affect the current produced by each of the units. In case of battery units, this may affect the available electrical charge that each unit may provide before it empties. For the sake of explanation, it is assumed that unit 110A has a production capacity higher than the average of the array; unit 110B has an average production capacity, and unit 110C has a production capacity lower than the average capacity. It is assumed that unit 110A produces I_{CELL}A which is higher than I_{CELL}B produced by unit 110B; and that I_{CELL}B equals to I_{STRING} and higher than I_{CELL}C produced by unit 110C. Reference is made to FIG. 2A, which is a schematic illustration of a single arrangement 250′ comprising electrical producing unit 110′, compensation unit 112′ and a controller (not shown), according to embodiments of the present invention. Electrical producing unit 110′ is a single producing unit in an array of units such as array 110. The current provided by unit 110′ is denoted I_{CELL} and the current flowing through compensation unit 112′ is denoted I_{COMP}. It is assumed that I_{CELL} is different (higher or lower) than I_{STRING} by ΔI, in conformity to Kirchhoff's current law as applied to junction J, the sum of currents at the junction is expressed by:

I_{CELL}+I_{STRING}+I_{COMP}=0

Since |I_{CELL}|=|(I_{STRING}+ΔI)|, it follows that:

|I_{comp}|=|ΔI|

and the direction of flow of I_{COMP} is dictated by which is greater −I_{CELL} or I_{STRING}. For example, if I_{CELL}A equals I1′ of FIG. 1C, I_{CELL}B equals I2′ of FIG. 1C and I_{CELL}C equals I3′ of FIG. 1C and given that I_{CELL}B=I2′=I_{STRING} then I_{COMP}A equals ΔI₁ and I_{COMP}C equals ΔI₂.

The direction of flow of I_{COMP} as depicted in FIG. 2A, i.e. from junction J to the compensation unit 112′, indicates that I_{CELL} is greater than I_{STRING}. Thus, compensation unit 112′ should be adapted to compel current I_{COMP} of magnitude ΔI in a direction dictated by the magnitude relations between I_{CELL} and I_{STRING}. Accordingly, in case the electrical producing unit has its I_{CELL} equal to I_{STRING} or smaller than I_{STRING}, I_{COMP} may equal to zero or equal to the respective ΔI, respectively, and may flow from compensation unit 112′ to junction J, as the case may be. Accordingly, in reference again to FIG. 2, compensation current I_{COMP}A of compensation unit 112A is ΔI₁ and the direction of flow is from J_{A} to unit 112A; compensation current I_{COMP}B of compensation unit 112B is zero and compensation current I_{COMP}C, of compensation unit 112C, is ΔI₂ in the direction from compensation unit 112C to junction J_{C}.

Reference is made to FIG. 2B, which is a schematic illustration of array 200 of electrical producing units each connected to a respective compensation unit and respective controller unit, according to embodiments of the present invention. Reference is also made to FIG. 2C, which is a schematic illustration of string 400 of electrical producing units 110 each connected to a respective equalization unit 215, according to embodiments of the present invention. The currents I_{CELL}A, I_{CELL}B, I_{CELL}C provided by electrical producing units 110A, 110B and 110C respectively may differ from one another. The common current provided by system 200 or 400 is I_{STRING}. An arrangement 250 of an electrical producing cell 110, a respective compensation unit 112 and a respective controller unit 220 will be denoted hereinafter a compensated producing unit. Accordingly, compensated producing unit 250A comprising electrical producing unit 110A, compensating unit 112A and controller unit 220A, and similarly with compensated arrangements 250B and 250C. It will be apparent to one skilled in the art that the discussion of the operation of system 200 of FIG. 2B, which considers three compensated producing units, 250A, 250B and 250C, is applicable to virtually any number of compensated producing units from two and up. String 400, comprising any number N (N>1) of electrical producing units 110 and respective equalization units 215, is considered a closed system with respect to energy calculations, e.g., substantially the only energy that enters into (or is stored in at a given starting moment) string 300 is that energy produced (or provided) by electrical producing units 110A, 110B . . . 110N, and substantially the only energy that exits from string 300 is that calculated by I_{STRING} multiplied by the accumulated string 400 voltage V_{STRING} between terminal 412, 414 of string 400. As such, energy accumulated for example in compensating unit 112A of electrical producing cell 110A having a production capacity above the average of system 200 or system 400 contributes its excess energy to compensating units of electrical producing unit with producing capacity below the average of system 200 or 400, for example compensating unit 112C (FIG. 2B). Applying the law of conservation of energy on systems 200, 400 ensures the operation of systems 200, 400 such that each compensated producing unit, such as units 250A, 250B, etc. may operate to compensate the current production capacity of its respective electrical producing unit thus allowing that electrical producing unit to operate at its respective maximum power point (MPP) or at its right discharging rate, as the case may be, while enabling systems 200, 400 to provide maximal power. According to embodiments of the present invention, the averaging of excess current (or electrical charge) of electrical producing units with excess production capability with those units with shortage of production capability by exchanging or conveying excess production power along string 400 towards units with shortage of production capability may be done without requiring any dedicated electrical bus, or wiring. The power swap, or transfer, is done over the string cables or wires themselves. When the power production units 110 are batteries, string 400 comprises also a central controlling unit as will be explained in details herein below.

When array 110 is an array of batteries, central controller unit 430 should be part of system 400, as is described in details herein below. Central controller 430 may be embodied by a dedicated controller, a CPU, a microcontroller or any other suitable controller. Additionally or alternatively, central controller unit 430 and specific controller units 120 may be embodied in a single controller, microcontroller, CPU or any other suitable controller. Central controller unit 430 may comprise memory unit (not shown), Input/Output (I/O) unit (not shown) for example to receive data indicative of the capacity of each battery. Additionally, system 400 may comprise current pickup device 430A, which may measures the magnitude of I_{STRING}, for example, constantly, or at regular intervals, to provide to central controller 430 a signal indicative of I_{STRING}.

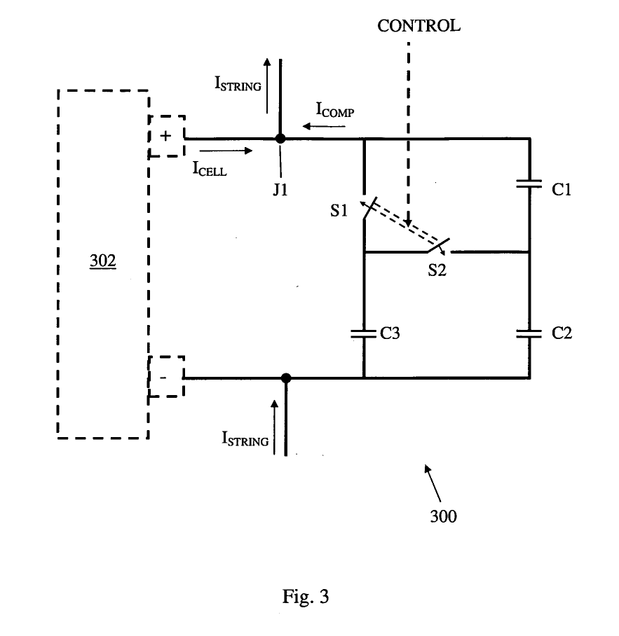

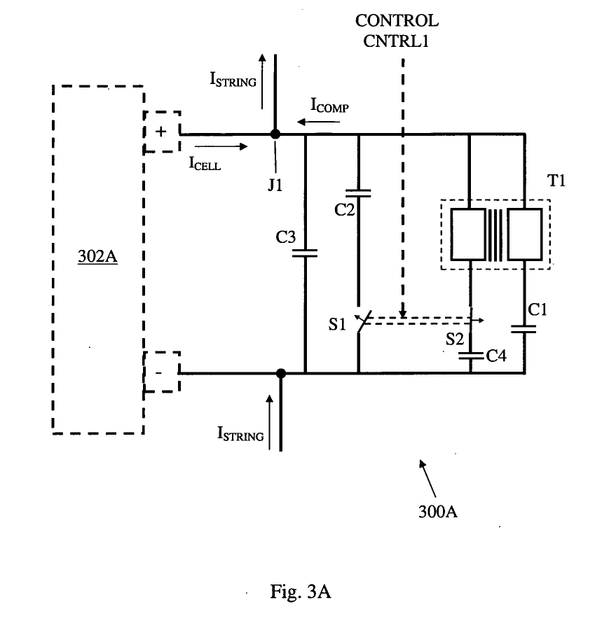

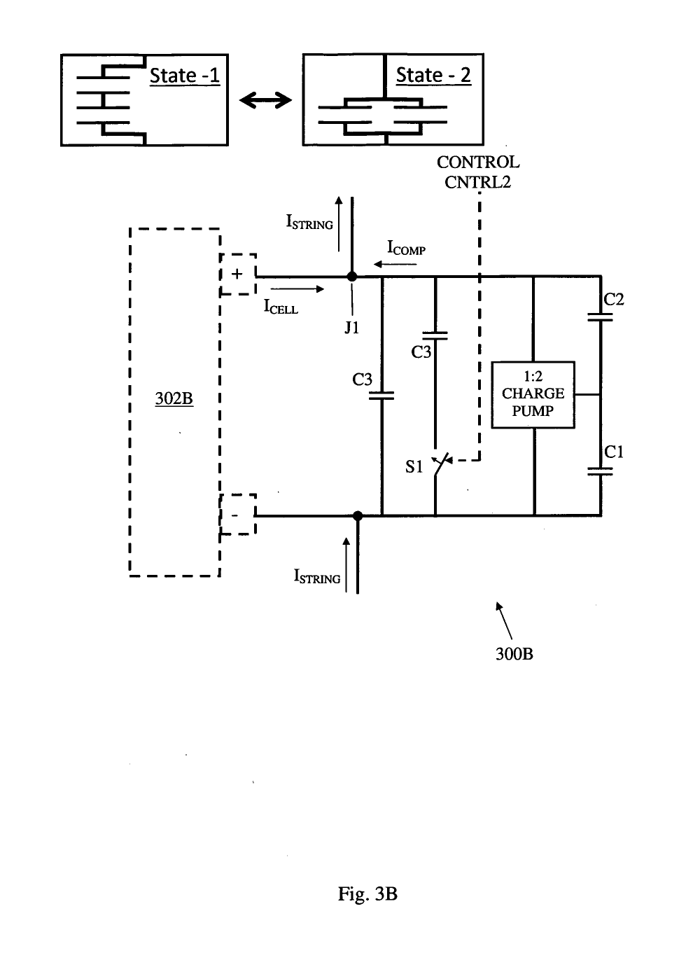

Reference is made to FIG. 3, which is a schematic illustration of compensation unit 300, according to an embodiment of the present invention. Unit 300 includes a 1:2 ratio charge pump and it is not drawn to details. Switches S1 and S2 are configured to close/open alternatively with respect to each other, e.g., when S1 is closed S2 is opened and vice versa. For simplicity of explanation, it is assumed that the capacitance of C1, C2 and C3 equals to C; however, it will be understood that in other embodiments of the invention, this need not be the case. Energy transferred to compensation unit 112—E_{TRANS} may be calculated based on the following:

$$\begin{matrix}{E}_{TRANS} = ( C \times {( \frac{V}{2} )}^{2} / 2 & ( 1 ) \\ State 1 ( S 1 is closed , S 2 is opened ) : {C}_{EQUIVALENT} = \frac{3}{2} C & ( 2 ) \\ State 2 ( S 1 is opened , S 2 is closed ) : {C}_{EQUIVALENT} = \frac{2}{3} C \\ {E}_{TRANS} = \vert [ \frac{{CV}^{2}}{2} + 2 \cdot \frac{{C ( \frac{V}{2} )}^{2}}{2} ] - [ 2 \cdot \frac{{C ( \frac{2}{3} V )}^{2}}{2} + \frac{{C ( \frac{V}{3} )}^{2}}{2} ] \vert = \vert {CV}^{2} [ ( \frac{1}{2} + \frac{1}{4} ) - ( \frac{4}{9} + \frac{1}{18} ) ] \vert = \\ = \vert {CV}^{2} [ \frac{3}{4} - \frac{1}{2} ] \vert = \vert \frac{1}{4} {CV}^{2} \vert J \\ {I}_{C} = C \times ( d V / d t ) \\ & ( 3 )\end{matrix}$$

D: Duty cycle (fraction of 1): 0<D<1

$$\begin{matrix} {I}_{C} ( State 1 ) = ( \frac{2}{3} C \times \frac{V}{2} ) / D & ( 4 ) \\ {I}_{C} ( State 1 ) = ( \frac{2}{3} C \times \frac{V}{2} ) / D & \\ \begin{matrix}{I}_{COMPENSATION} = {I}_{COMPENSATION} ( State 1 ) - {I}_{COMPENSATION} ( State 2 ) \\ {I}_{COMPENSATION} = 0 when {I}_{C ( Equivalent )} ( state 1 ) \\ = {I}_{C ( Equivalent )} ( State 2 )\end{matrix} \\ ∴ ( \frac{3}{2} C \times \frac{V}{2} ) / D = ( \frac{2}{3} C \times \frac{V}{2} ) / ( 1 - D ) ( 6 ) \\ ( \frac{2}{3} C ) \cdot ( \frac{Δ V}{DT} ) = ( \frac{2}{3} C ) \cdot ( \frac{Δ V}{( 1 - D ) T} ) \\ ( \frac{2}{3} ) \cdot ( \frac{1}{D} ) = ( \frac{2}{3} ) \cdot ( \frac{1}{( 1 - D )} ) \\ \begin{matrix}{D}_{I ( Compensation ) = 0} = \frac{18}{26} \\ = 0.692\end{matrix} ( 7 ) & ( 5 )\end{matrix}$$

Thus, by controlling the magnitude of variable D, the duty cycle fraction (or normalized coefficient), it is possible to control the magnitude and direction of the current I_{COMPENSTAION}, where at D=0.692 this current equals to zero. The control of the magnitude of D may be done by signal 120_{CNT} (FIG. 2) of each of the array cells, which, according to the example of compensation unit 300 (FIG. 3), may have the general shape of a square wave having the duty cycle D/1-D. Switches S1 and S2 may be realized as dry contact switches, solid state switches, such as metal oxide semiconductor field effect (MOSFET) transistors, and the like, as is known in the art. It will be apparent to those skilled in the art that the specific topology of system 300 is not binding and other, similar circuits or topologies may be used to achieve the same or similar effect of controlling the direction and magnitude of current through the system.

It will be apparent to those skilled in the art that any device which is capable compel current with a controllable magnitude and direction through may be used to realize compensate unit 112 (FIG. 2). Reference is made to FIGS. 3A and 3B, which are two additional examples of embodiments of compensate unit, such as unit 112 (FIG. 2), according to the present invention. FIG. 3A depicts compensating unit 300A embodied using a transformer charge pump topology employing capacitors C1, C2, C3 transformer T1 and switches S1, S2 operating alternatively by a single control command CNTRL1 according to embodiments of the present invention. In case of 300A the transformer T1 has current magnification ratio bigger then 1 and so when S2 is toggled and current flows through first branch of T1 bigger current is inducted through second branch of the transformer but to the opposite direction and the overall current direction is upwards and the magnitude depends upon frequency and duty cycle. When downwards current is required S1 is toggled. FIG. 3B depicts compensating unit 300B embodied using a charge pump topology employing capacitors C1, C2, C3, C4 and switch S1 controlled by control signal CNTRL2. A charge pump is a known current multiplier/voltage divider device. In this case, the current step-up ratio is 1:2 and because the circuit operates as an AC circuit the capacitors that may be used for low currents (in the range of few Amperes) may be sufficient for much higher currents, in the range of hundreds Amperes. When downwards current is required, S1 is used. Due to the alternating operation of S1, C1 and C2 effectively change their relative configuration from state 1 to state 2 as indicated in the small boxes at the top of the drawing.

In case the electrical producing units are of the type that produces current in response to exposure to another type of energy, such as PV cells (or substrings of PV cells), in order to allow each of the PV type electrical producing units to operate at its specific MPP the current of each cell should conform to the specific MPP of the cell. Since the specific provide-able currents may be different from each other and the string current I_{STRING} is common, it is required to allow extra current, e.g. current higher than I_{STRING}, of cell with high capacity, to find path to flow through. It is also desired to enable cells with current lower than I_{STRING} to receive complementary current. The common current of a string of PV cells, I_{STRING}, may be the average current of the cells, or sub-strings of the string. For each PV cell or sub-string the specific operational point may be tuned, or adjusted to be at, are very close to the specific MPP of that cell (or sub-string), by adjusting the current of the cell, I_{CELL}, so that V_{CELL} reaches close to the specific operational point OP, OP′ (FIGS. 1A and 1C). As described above with respect to FIG. 1C, the bi-linear approximations of actual I-V curves of typical PV cells may be considered good approximation. Accordingly, the control function for adjusting the specific OP of a cell should be able to set an operational point by changing the specific current I_{CELL} of a cell within, typically 1 Ampere or less. The differences of currents between the various cells, for example the difference between I1′, I2′ and I3′ (FIG. 1C) may be in the order of 30% or 2.5 Ampere, Thus the magnitude of I_{STRING} is expected to be the average of these currents and the magnitude of I_{COMP} may be about half of this range. Thus the control function each controller unit 220 may be to set the direction and magnitude of I_{COMP} so that the respective compensation unit 112 enforces that compensation current.

In order to calculate the required magnitude and direction of I_{COMP} it is required to satisfy:

$$\frac{d I}{d V} = - 1 \qquad ( 8 )$$

Since the voltage across the terminals of each cell (or sub-string) is constantly measured (for example signal 110_{V} of FIG. 2), controller unit 120 may calculate along time dV/dt. Additionally, the value of I_{STRING} is substantially constant (in the time constants of the control cycle of controller unit 120) and therefore the changes in I_{COMP} is compelled by the operation of compensation unit 112 are the only changes of I. Thus, dI/dt=dI_{COMP}/dt which along time is known to controller unit 120. Thus:

$$\frac{d I}{d t} = \frac{d {I}_{COMP}}{d t} \qquad ( 9 )$$

Accordingly:

$$\begin{matrix}\frac{d I}{d V} = \frac{\frac{d {I}_{COMP}}{d t}}{\frac{d V}{d t}} \\ = \frac{d {I}_{COMP}}{d V} \\ = - 1\end{matrix} \qquad ( 10 )$$

And since all parameters are known, per cell or sub string, this control equation is solvable. Controller unit 120 may be embodied using a micro controller, a CPU, an analog computer, analog control circuitry, and the like.

In case the electrical producing units are batteries, the variation between the different cells are expressed in the amount of electrical charge each unit can provide before it reaches its practical lowest remaining charge that still may be consumed without causing undesired damage to the battery. With battery cells, optimal utilization of the total amount of electrical charge stored in the cells is when all cells, at least in a string reach their lowest discharging point concurrently. Otherwise, the cell that will reach its lowest discharging point first will practically disable the operation of the whole string. Assuming that at the beginning of utilization of battery cells array, such as array 110, all of the cells are charged to their maximum capacity, the difference in utilizable amount of charge from each cell dictates that the discharge of each battery should be done by different current—the lower the available charge the lower the discharge current. Thus, regulation of the operation of an array of battery-type cells is of the same nature as that of an array of PV cells, which is: allowing each cell to work at its optimal operational point by allowing each cell to provide the current that complies with the respective regulation scheme, and compensating under current as compared to I_{STRING} by the over current of the other cells. Accordingly, the control function for discharging batteries in an array of batteries should consider the consumable amount of charge in each battery, its rate of discharge and its lowest discharge point. The capacity of a battery is usually measured by its Ampere-Hours (AH) factor. The momentary capacity of a battery may be expressed by the actual Q_{CELL(t)}=AH₍ₜ₎ or as a fraction (e.g. percents) of its maximum capacity Q_{BATTERY(t)}=n % (of Q_{BATTERY} Max). In order to know the maximum capacity of each cell it is possible to measure the charged capacity (which is, substantially the dischargeable capacity) of each cell during charging phase of the array of battery cells and these values may be stored, for example, in the memory of unit 430 (FIG. 2C). Based on the information indicative of the capacity of each cell Q_{CELL(n)}, the average capacity Q_{CELL} of N cells of array 110 may be calculated:

$${Q}_{CELLav} = \frac{{\sum }_{1}^{N} {Q}_{CELL ( n )}}{N} \qquad ( 11 )$$

And the desired current from each battery cell, I_{CELL}, should satisfy at all time:

$${I}_{CELL} ( t ) = {I}_{STRING} ( t ) \cdot \frac{{Q}_{CELL}}{{Q}_{CELLav}} \qquad ( 12 )$$

Thus, as all parameters and variables are known, the control function may be carried out by central controller 430, to provide the value of Q_{CELLav} and further by each of the controllers of each battery cell (220) to compel momentary required value of I_{CELL}(t) to be provided by each battery cell.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

What is claimed is:

1. An apparatus comprising:
a string of units comprising at least two electrical energy producing units connected in series to provide string current, each of said units to provide said electrical energy via output terminals; and
a current equalization unit connected to each of said at least two energy producing units via said output terminals said current equalization unit adapted to individually control the magnitude and direction of current via said current equalization unit.

2. The apparatus of claim 1 wherein said current equalization unit is adapted to control the magnitude and direction of current via said current equalization unit so that the algebraic sum of the current produced by its respective electrical energy producing unit when operated at a defined operational point and the current flowing via said current equalization unit equals to said string current.

3. The apparatus of claim 2 wherein said operational point of each of said at least two electrical energy producing units is controlled to be substantially at the respective unit's maximum power point (MPP).

4. The apparatus of claim 2 wherein said operational point of each of said at least two electrical energy producing units is controlled so that all of said energy producing units are fully discharged at substantially the same time.

5. The apparatus of claim 1 wherein each of said electrical energy producing units comprise at least one photovoltaic (PV) cell connected in series to one another between said output terminals.

6. The apparatus of claim 1 wherein each of said electrical energy producing units is one from a list including battery and fuel cell.

7. The apparatus of claim 1 wherein said current equalization unit comprising a current compensation unit and a controller unit.

8. The apparatus of claim 7 further comprising a central controller unit to receive indication of the magnitude of said string current and of the average dischargeable capacity of said at least two electrical energy producing units and to provide individual signal to each of said controller units indicative of the desired discharge rate of its respective electrical energy producing unit.

9. The apparatus of claim 2 wherein said string current is the average of the currents produced by each of said at least two electrical energy producing units.

10. The apparatus of claim 8 wherein said average dischargeable capacity is received by:
$${Q}_{CELLav} = \frac{{\sum }_{1}^{N} {Q}_{CELL ( n )}}{N}$$
and
wherein said controller unit is adapted to control the current through it so as to satisfy:
$${I}_{CELL} ( t ) = {I}_{STRING} ( t ) \cdot \frac{{Q}_{CELL}}{{Q}_{CELLav}}$$
where
QCELL(n) is the fully charge capacity of unit n of said at least two electrical energy producing units,
Q_{CELLav} is the average dischargeable capacity,
N is the number of said at least two electrical energy producing units, and
I_{CELL}(t) is the momentary current through the respective electrical producing unit.

11. A method comprising:
connecting at least two electrical energy producing units, each having two output terminals, in series to provide string current;
connecting a current equalization unit to the output terminals of each of said electrical energy producing units; and
individually controlling the magnitude and direction of current flowing via each of said current equalization units.

12. The method of claim 11 wherein said controlling of the magnitude and direction of current flowing via each of said current equalization units is so that the algebraic sum of the current produced by each electrical energy producing unit when operated at a defined operational point and the current flowing via its respective current equalization unit equals to said string current.

13. The method of claim 12 wherein said controlling of the magnitude and direction of current flowing via each of said current equalization units is to operate its respective electrical energy producing unit substantially at its respective maximum power point (MPP).

14. The method of claim 12 wherein said operational point of each of said at least two electrical energy producing units is controlled so that all of said energy producing units are fully discharged at substantially the same time.

15. The method of claim 11 wherein each of said electrical energy producing units comprise at least one photovoltaic (PV) cell connected in series to one another between said output terminals.

16. The method of claim 11 wherein each of said electrical energy producing units is one from a list including battery and fuel cell.

17. The apparatus of claim 11 wherein said current equalization unit comprising a current compensation unit and a controller unit.

18. The apparatus of claim 17 further comprising connecting a central controller unit to receive indication of the magnitude of said string current and of the average dischargeable capacity of said at least two electrical energy producing units and to provide individual signal to each of said controller units indicative of the desired discharge rate of its respective electrical energy producing unit.

19. The method of claim 12 wherein said string current is the average of the currents produced by each of said at least two electrical energy producing units.

20. The method of claim 18 wherein wherein said average dischargeable capacity is received by:
$${Q}_{CELLav} = \frac{{\sum }_{1}^{N} {Q}_{CELL ( n )}}{N}$$
and
wherein said controller unit is adapted to control the current through it so as to satisfy:
$${I}_{CELL} ( t ) = {I}_{STRING} ( t ) \cdot \frac{{Q}_{CELL}}{{Q}_{CELLav}}$$
where
QCELL(n) is the fully charge capacity of unit n of said at least two electrical energy producing units,
Q_{CELLav} is the average dischargeable capacity,
N is the number of said at least two electrical energy producing units, and
I_{CELL}(t) is the momentary current through the respective electrical producing unit.
